(19) United States
(12) Patent Application Publication
(10) Pub. No.: US 2018/0245985 A1
(43) Pub. Date: Aug. 30, 2018

(54) SYSTEM FOR MEASURING THE DURATION, TIME PROFILE AND SPECTRUM OF AN ULTRA-FAST LASER PULSE

(71) Applicants: UNIVERSITE DE BORDEAUX, BORDEAUX (FR); CENTRE NATIONAL DE LA RECHERCHE SCIENTIFIQUE, PARIS (FR)

(72) Inventor: Antoine DUBROUIL, TALENCE (FR)

(21) Appl. No.: 15/757,588

(22) PCT Filed: Sep. 5, 2016
(86) PCT No.: PCT/FR2016/052191

§ 371 Date: Mar. 5, 2018

(30) Foreign Application Priority Data
Sep. 4, 2015 (FR) 1558223

(51) Int. Cl. G01J 11/00; H01S 3/00

(52) U.S. Cl. CPC G01J 11/00; H01S 3/0014; H01S 3/0078; H01S 3/0071; H01S 3/005

(57) ABSTRACT

Disclosed is a system for measuring the duration, time profile and spectrum of an ultra-fast laser pulse, including a single-shot optical correlator with wavefront division, a non-linear optical crystal arranged so that a first divided wavefront and a second divided wavefront superpose in the non-linear optical crystal, an optical system forming an image of the non-linear optical crystal on a detection system, a filtering device arranged between the non-linear optical crystal and the detection system and configured to detect both a second-order single-shot interferometric autocorrelation trace at the optical double frequency as well as at least one other first-order single-shot interferometric autocorrelation trace at the fundamental optical frequency or a second-order intensimetric trace at the optical double frequency.

### TECHNICAL FIELD TO WHICH THE INVENTION RELATES

The present invention generally relates to the field of systems and methods for measuring ultrashort laser pulses, in particular, for measuring the duration, for measuring the spectrum of the pulses or for the full reconstruction of the temporal intensity and phase profile.

In the present document, it is meant by ultrashort laser pulse a pulse having a duration of the order of the picosecond to the femtosecond. These ultrashort laser pulses generally extend over a wide spectral band, from a few nanometres for the picosecond pulses to a few tens or even hundreds of nanometres for the femtosecond pulses. The spectral band may be located in the ultraviolet, visible and/or infrared domain.

The invention more particularly relates to a system and a method for measuring the duration or the temporal profile of an ultrashort laser pulse and possibly the spectrum and/or the phase of ultrashort laser pulses.

### TECHNOLOGICAL BACK-GROUND

Various technologies and various light pulse measurement systems are already known. Those systems are mainly classified into two great categories: the autocorrelators and the phase measurement systems.

The autocorrelators allow measuring the duration of the pulses by making an hypothesis about the shape of their temporal profile. There exist multi-shot autocorrelators and single-shot autocorrelators. Herein, the interest is more particularly turned to the single-shot autocorrelators.

A second-order single-shot optical intensity autocorrelator generally includes a beam splitter to form two replicas of the source pulse beam at a fundamental frequency (ω), a second-order (possibly third-order) non-linear optical crystal in which the two replicas cross each other, and a detector measuring the intensity profile of the second-harmonic beam (2ω) as a function of the delay between the two replicas. Such an intensimetric optical autocorrelator measures the envelope of the second-order signal. Combined to a detection system having an interferometric resolution, a second-order single-shot interferometric optical autocorrelator is obtained.

Diels et al. (Control and measurement of amplitude of ultrashort pulse shapes—in amplitude and phase—with femtosecond accuracy Appl. Optics, Vol. 24, n° 9, p. 1270-1282, 1985) disclosed a method for calculating the temporal shape and the phase of pulses based on a record of the pulse spectrum, a measurement of the intensity autocorrelation function and a measurement of the interferometric autocorrelation function.

F. Salin et al. (Autocorrélation interférométrique monocoup d'impulsions femtosecondes, Revue Phys. Appl. 22, p. 1613-1618, 1987) have proposed a single-shot interferometric autocorrelator comprising a frequency-doubling non-linear crystal in which two synchronous beams cross each other with a low incidence angle, a UV filter to filter the frequency-doubled beams and a multi-channel detector. The KDP crystal forms three frequency-doubled beams that coherently recombine each other on the detector to form interference fringes whose contrast is modulated. The analysis of these interference fringes allows extracting the duration of a single-shot pulse.

Different phase measurement systems (of the Spider, 2DSI, FROG, SRSI type . . . ) allow reconstructing the temporal intensity and phase profile of the pulses and provide a complete temporal characterization. However, the phase measurement systems are more complex and more difficult to use than the autocorrelators. The devices of the FROG type use a spectrometer to spectrally resolve the autocorrelation trace and to hence produce a spectrogram that gathers the spectral information for each delay between the two replicas of a pulse. The analysis of the spectrogram by an iterative algorithm then allows extracting the temporal intensity and phase profile of the pulses. In the case of a GRENOUILLE device, this is the angular phase matching in a thick non-linear crystal that allows producing the spectrogram. In the case of the Spider and SRSI devices, spectral interferences are measured between two replicas of the pulse having undergone different interactions. A Fourier transform analysis hence allows extracting the phase of the pulse and hence reconstructing the temporal intensity profile thanks to the previous or simultaneous measurement of the spectrum. The interferences are acquired in 2D in the case of the 2DSI.

Generally, the laser pulse measurement systems require an accurate alignment and a specific expertise to produce reliable results. The phase measurement requires in particular very accurate adjustments. The autocorrelators provide a measurement of the duration of the laser pulses by making an hypothesis about the temporal profile of these laser pulses. Nevertheless, the use of an autocorrelator is relatively less complex than that of a phase measurement system. The autocorrelators are hence extremely useful to optimize the duration of the pulses in real time or to check the stability over time of the performance of a laser. These two techniques are complementary and a user of an ultrashort pulse laser must generally acquire two devices: an autocorrelator and a phase measurement system.

Nevertheless, whatever the device, a specific expertise is required to use it and an accurate phase of adjustment is necessary. This adjustment phase may be time consuming. Moreover, the quality and exactitude of the measurements depend on this adjustment phase. Also, this setup phase forbids the use of these device in vacuum, whereas a need to perform these measurements in vacuum exists for certain applications.

### OBJECT OF THE INVENTION

In order to remedy the above-mentioned drawbacks of the prior art, the present invention proposes a system for measuring the duration, the temporal profile and the spectrum of an ultrashort laser pulse.

More particularly, it is proposed according to the invention a system for measuring the duration, the temporal profile and the spectrum of an ultrashort laser pulse, including a single-shot optical autocorrelator comprising a wavefront-splitting optical component arranged so as to receive a collimated wavefront of fundamental optical frequency (ω) coming from an ultrashort laser pulse source and to spatially split the collimated wavefront of an ultrashort light pulse into a first split wavefront propagating along a first direction and a second split wavefront propagating along a second direction forming a non-null angle with the first direction, a non-linear optical crystal, which is preferably a second harmonic generator, arranged at a determined distance from the wavefront-splitting optical component so that the first split wavefront and the second split wavefront are superimposed to each other in the non-linear optical crystal, an optical system forming an image of the non-linear optical crystal on a detection system spatially resolved in at least one direction, a filtering device arranged between the non-linear optical crystal and the detection system, the filtering device and the detection system being configured to detect, on the one hand, a second-order single-shot interferometric autocorrelation trace at the double optical frequency (2ω) and, on the other hand, at least another single-shot autocorrelation trace of the first-order interferometric type at the fundamental optical frequency (ω) or of the second-order intensimetric type at the double optical frequency (2ω), and a signal processing system configured to analyse, on the one hand, the second-order single-shot interferometric autocorrelation trace at the double optical frequency (2ω) and, on the other hand, the other single-shot autocorrelation trace, and to deduce therefrom a measurement of the duration, the temporal profile and the spectrum of an ultrashort laser pulse. The measurement of the fundamental spectrum of the pulse may be performed indirectly thanks to the processing of the first-order autocorrelation trace. Indeed, by applying the general theorem of Wiener-Khinchine to the case of the electromagnetic waves, it is observed that the spectral power density and hence the fundamental spectrum of the pulse is given by the Fourier transform of the first-order autocorrelation. The measurement of the fundamental spectrum and/or the doubled spectrum of the pulse may also be made by means of a spectrometer.

Other non-limitative and advantageous characteristics of the system for measuring the duration and temporal profile of an ultrashort laser pulse according to the invention, taken individually or according to any technically possible combination, are the following:

the wavefront-splitting optical component includes a Fresnel bi-prism or a Fresnel bi-mirror having a fixed or symmetrically adjustable apex angle;

the Fresnel bi-prism or the Fresnel bi-mirror has an angle that is adjustable according to the duration of the ultrashort laser pulse to be measured;

the distance D between the wavefront-splitting optical component and the non-linear optical crystal is comprised between: 0.1*delta and 0.5*delta, where delta is equal to

$$\frac{∅}{2 \times tan ( \frac{α}{2} )} ,$$

and where Ø is the inlet diameter of the device adapted to receive a beam of diameter higher than or equal to 3 mm, and α the angle between the two beams (α is equal to (180−A)·(n−1) in degrees, where A is the apex of the bi-prism and n the refractive index of the prism material or, respectively, α is equal to 2*(180−A) for a Fresnel bi-mirror, where A represents the apex of a bi-prism complementary of the bi-mirror), so that the effect of the diffraction is negligible with respect to the signal that it is desired to measure;

the system may include a plurality of Fresnel bi-prisms each having a determined apex angle and further comprising a switching system adapted to select a Fresnel bi-prism among the plurality of Fresnel bi-prisms and to place the selected bi-prism at a distance D from the non-linear optical crystal, as defined hereinabove;

the non-linear optical crystal has a thickness comprised between 5 μm for a femtosecond pulse and a few millimetres for a picosecond pulse, and preferably between 5 micrometres and 50 micrometres, and a suitable phase matching to allow an optical frequency doubling as a function of the spectral width of the pulse;

the second-harmonic-generator non-linear optical crystal has an input spectral band for the frequency doubling that extends from 410 nm to 3.5 micrometres, for example for an ultra-thin BBO crystal, or of 2.5 to 12 micrometres for an AgGaSe₂ crystal,

the detector comprises a photodiode strip, a CCD strip, a CMOS strip or a CCD or CMOS camera having a micrometric spatial resolution in one or two dimensions;

the filtering device includes a spatial filter able to be switched in opening between a first and a second opening, the first opening being configured to let through to the detection system, on the one hand, the direction of propagation of the bisector of the first and second directions and, on the other hand, the first direction and/or the second direction, so as to form the second-order single-shot interferometric autocorrelation trace, and respectively, the second opening being configured to selectively let through to the detection system the axis of propagation along the bisector of the first and second directions, while blocking the first and second directions to form the other single-shot autocorrelation trace of the second-order intensimetric type;

the filtering device includes a spectral filter configured to selectively filter the double optical frequency and to block the fundamental optical frequency;

the spectral filter comprises a coloured glass filter or a dichroic mirror, a multilayer filter or is made by spatial separation of the beams;

the detection system includes a camera comprising a first and a second spatially-resolved detection zones and the filtering device includes a spectral filter having a first and a second spectral filtering zones, the first spectral filtering zone being configured to selectively let through the double optical frequency to the first detection zone while blocking the fundamental optical frequency, and the second spectral filtering zone being configured to selectively let through the fundamental optical frequency to the second detection area while blocking the double optical frequency;

the detection system includes a camera comprising a first and a second spatially-resolved detection areas and wherein the filtering device includes a spatial filter having at least a first spatial filtering zone and a second spatial filtering zone, the first spatial filtering zone being configured to let through, on the one hand, the direction of propagation of the bisector of the first and second directions and, on the other hand, the first and/or the second direction, to the first detection area, so as to form the second-order single-shot interferometric autocorrelation trace, and respectively, the second spatial filtering zone being configured to selectively let through the direction of propagation along the bisector of the first and the second directions while blocking the first and second directions towards the second detection area, to form the other single-shot autocorrelation trace of the second-order intensimetric type.

In a particular embodiment, the system further comprises a spectrometer configured to record the spectrum at 2ω of the light pulse and possibly the fundamental spectrum (ω), and wherein the signal processing system is configured to deduce therefrom a measurement of the light pulse phase.

In another particular embodiment, the detection system includes an imaging spectrometer having an inlet slot, a spectrally-dispersive optical system and a detector spatially resolved in two directions, the filtering device (21, 23, 24) and the imaging spectrometer being configured to detect, on the one hand, a spectrally-resolved second-order single-shot intensimetric autocorrelation trace, and on the other hand, a spectrally-resolved single-shot interferometric autocorrelation trace;

the spectrally-dispersive optical system comprises a transmission or reflection diffraction grating;

the optical system forming the image of the non-linear optical crystal on the inlet slot of the imaging spectrometer includes an achromatic optical system comprising a first spherical mirror illuminated with an incidence angle lower than 4 degrees, and a second mirror configured to separate a reflected optical beam from an incident optical beam on the first spherical mirror;

the imaging spectrometer includes another mirror-based achromatic optical system configured to form an image of the inlet slot on the detector, the other mirror-based achromatic optical system comprising a spherical mirror illuminated with an incidence angle lower than 3 degrees, and another mirror configured to separate a reflected optical beam from an incident optical beam on said spherical mirror;

the system further includes an optical alignment diaphragm adjacent to the wavefront-splitting optical component, the alignment diaphragm being positioned vertically above the first foot of the device, hence forming a pivot point for the alignment of the device to the optical axis. This optomechanical configuration allows aligning directly the device to the laser beam contrary to the prior art where this is the laser beam that is aligned in the device by means of two injection mirrors and not the device that allows the alignment.

### DETAILED DESCRIPTION OF AN EXEMPLARY EMBODIMENT

The following description in relation with the appended drawings, given by way of non-limitative examples, will allow a good understanding of what the invention consists in and of how it can be implemented.

In the appended drawings:

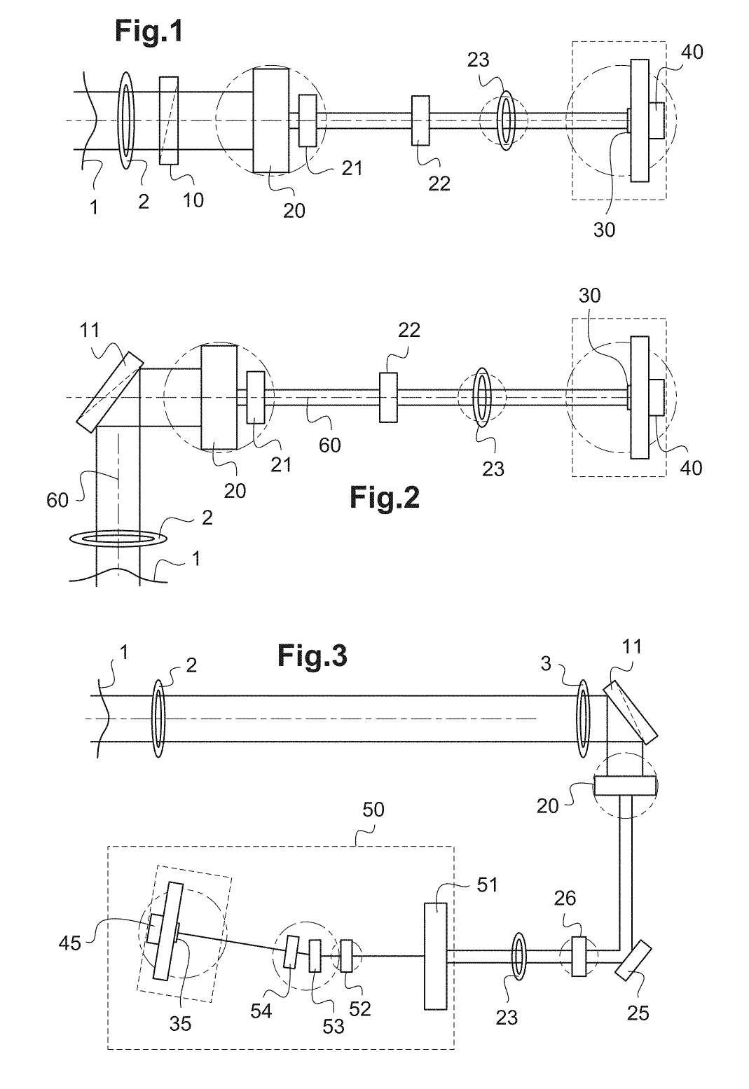

FIG. 1 schematically shows a system for measuring the duration of a laser pulse based on an intensimetric or interferometric autocorrelator according to a first embodiment of the invention;

FIG. 2 schematically shows a variant of the first embodiment of the invention;

FIG. 3 schematically shows a system for measuring the duration and phase of a laser pulse based on an autocorrelator combined with an imaging spectrometer according to a second embodiment of the invention;

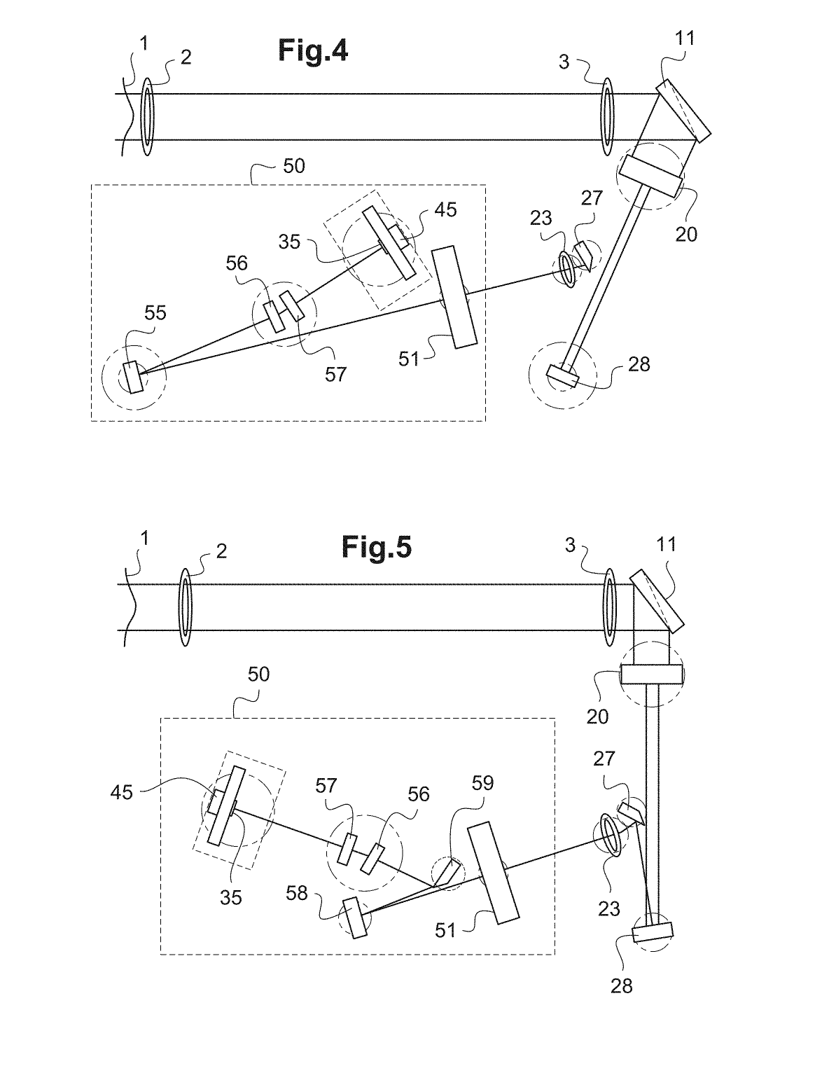

FIG. 4 schematically shows a first variant of the second embodiment of the invention;

FIG. 5 schematically shows a second variant of the second embodiment of the invention;

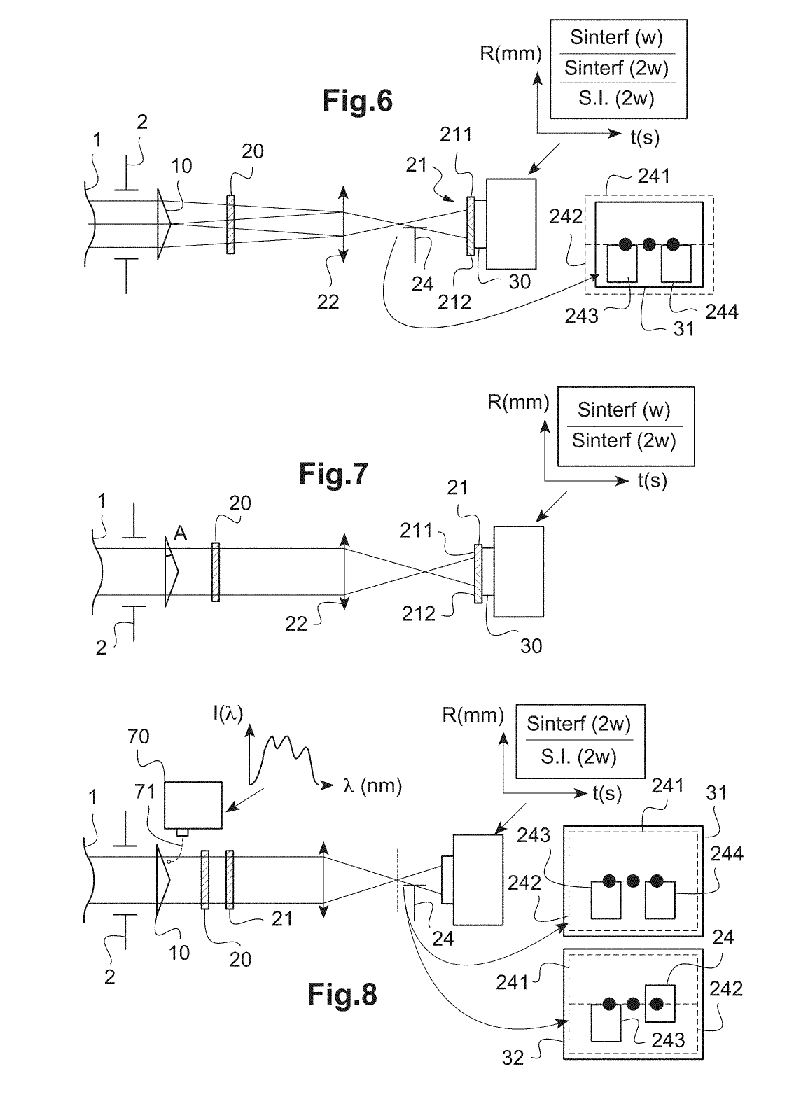

FIG. 6 schematically shows a particular embodiment of a spectral and spatial filtering device;

FIG. 7 schematically shows a variant of a spectral filtering device;

FIG. 8 schematically shows a particular embodiment including a spectrometer combined with a single-shot optical autocorrelator with another variant of a spectral and spatial filtering device.

### DEVICE

In FIG. 1 is shown a system for measuring the duration or the temporal profile of a laser pulse, based on a intensimetric or interferometric autocorrelator. This system includes a first iris 2, a Fresnel bi-prism 10, a second-harmonic-generator non-linear optical crystal 20, a spectral filter 21, a lens 22, a second selection iris 23, a detector 30 and a connector 40 connected to a signal processing system. Advantageously, the components of the system of FIG. 1 are mounted in line in a casing, which allows an easy alignment of the system to the longitudinal optical axis 60 of the beam of the ultrashort light pulse source.

Let's consider an ultrashort laser pulse forming a collimated incident beam. The ultrashort laser pulse has a wavefront 1. The ultrashort laser pulse has a spectrum that is extended (non-monochromatic) and comprises in particular a fundamental optical frequency ω. Generally, the spectrum of the ultrashort laser pulse is defined by a central frequency and a spectral width that is variable as a function of the picosecond to femtosecond duration of the pulse.

The first iris 2 defines a first mark of alignment of the optical axis to centre the incident beam onto the Fresnel bi-prism 10 and allows limiting the spatial extent of the beam. The Fresnel bi-prism is a single-piece optical component conventionally used in the wavefront-splitting interferometers.

Particularly advantageously, the system includes a first height-adjustable foot arranged in the plane of the first iris 2, and a second height-adjustable foot arranged in a plane near the plane of the detector 30. The bi-prism 10 is placed the nearest to the first iris 2. Hence, the centering of the incident beam to the first iris ensures the centering to the bi-prism. The first foot constitutes a pivot point at the first iris 2, which forms an alignment mark. Hence, it is possible to align the second iris 23 with respect to the light beam, without affecting the alignment with respect to the first iris 2. The system of FIG. 1 is hence accurately, easily and rapidly aligned.

Advantageously, the incident beam has an intensity distribution having an axial symmetry with respect to the optical axis 60 of propagation of the beam. The bi-prism 10 is arranged so that the base of the bi-prism receives the incident beam. The edge between the two prisms is placed transversally to the optical axis of propagation of the incident beam. Hence, each prism forming the bi-prism 10 receives one half of the incident beam or one half of the light pulse 1. The bi-prism 10 allows splitting the wavefront 1 of the incident beam into two spatially-split wavefronts, each split wavefront being symmetrically deflected with respect to the edge of the bi-prism. Hence, at the exit of the bi-prism, a first split front propagates along a first direction inclined by a deflection angle with respect to the optical axis of the incident beam and a second split beam propagates along a second direction inclined by a symmetrical deflection angle with respect to the optical axis of the incident beam. In other words, the first direction and the second direction are symmetrically inclined with respect to the longitudinal optical axis 60. The deflection angles conventionally depend on the angles and on the refractive index of the bi-prism 10. The first split beam and the second split beam cross each other in a covering zone in which interferences are formed and in particular in the frequency-doubling crystal 20. The split beams are also called replicas of the incident beam.

An advantage linked to the use of a Fresnel bi-prism having a low angle, for example of the order of 2.5 degrees (corresponding to an apex angle of 175 degrees) is to increase the fringe spacing of the autocorrelation interferometric beam, which allows, as described in detail hereinafter, spatially resolving this fringe spacing on the image detector 30.

The bi-prism 10 is specially designed to limit the effects of diffraction of the beam on the median edge of the bi-prism. The bi-prism is generally symmetrical with respect to the median edge. The smallest angle of the bi-prism is preferably higher than 1 degree. For example, the bi-prism is made of BK7, melted silica, calcium fluoride or any other material transparent to the wavelength of interest. Preferably, the optical quality of the edge of the bi-prism is controlled so as to limit the diffraction.

A second-harmonic-generator non-linear optical crystal 20 is placed at a predetermined distance from the bi-prism 10, transversally to the optical axis of propagation of the incident beam, so that the interferences occur inside the non-linear optical crystal 20. A very thin non-linear optical crystal 20 is selected, which has a thickness determined as a function of the pulse duration, for example between 5 micrometres and 500 micrometres for an ultrashort pulse, and between 500 micrometres and a few millimetres for a pulse with a duration comprised between 500 fs and 10 ps. In one example, the non-linear optical crystal 20 has a thickness of 10 micrometres. The material of the non-linear optical crystal 20 is chosen, as a function of the wavelength of interest, among the known materials, such as BBO, KDP, KTP, LiIO₃, BiBO, LBO, AgGaS₂, AgGaSe₂, ZnGeP₂, GaSe, AgGaGeS₄ or KTA. The thin non-linear optical crystal 20 is preferably fixed, for example by optical bonding, on a substrate, for example made of silica glass.

The non-linear optical crystal 20 is configured to allow a doubling of the fundamental beam frequency. The low thickness of the non-linear optical crystal 20 allows performing a optical frequency doubling over a very wide spectral band corresponding to ultrashort light pulses that can reach durations shorter than 5 femtoseconds. By way of example, a thin non-linear optical crystal made of BBO allows doubling the frequency of an incident beam having a fundamental frequency ω in a very wide spectral band, extending from 410 nm to 3500 nm. Other crystals may be used for other spectral ranges.

Another technical effect of this low thickness is to limit the efficiency of the frequency doubling, contrary to what is generally searched in the prior-art autocorrelators, in which it is generally searched to maximize the efficiency of the frequency doubling.

One advantage linked to the low thickness of the non-linear optical crystal 20 is to increase the threshold of the damages liable to be induced by a pulse of strong power, by comparison with a thicker no-linear optical crystal. The low-thickness non-linear optical crystal 20 is hence compatible with pulses having a power extending over a range of a few milliWatts to 1 or a few Watts. This technical characteristic allows using the autocorrelator with a direct beam (without previous attenuation of the vitreous reflection or beam sampler type) in most of the cases. Also, to further increase the incident energy acceptable by the device, a variable optical density wheel may be installed on the path of the beam 2ω. The wheel is advantageously placed between the lens 22 and the iris 23 close to the lens focal point. When the wheel is positioned at 45 degrees from the incident beam, the reflection on the wheel may be used to illuminate an alignment target and hence produce an alignment mark visible from the outside of the device. Thanks to the variable optical density wheel and to the thin non-linear crystal, it is possible to detect a laser pulse without damage and to perform a valid single-shot measurement up to an intensity of more than 5 mJ per pulse at 25 fs with a beam of 20 mm of diameter. In other words, the device may operate up to intensities of 10¹¹ W/cm², which is far higher than the usual maximum intensity of the order of about 10⁸ W/cm² to perform duration measurements.

The interference zone is very spread. On the other hand, the distance at which the bi-prism is placed is far more restricted.

More precisely, the distance between the non-linear optical crystal 20 and the bi-prism is determined as a function of the deflection angle of the bi-prism according to a conventional geometric calculation formula.

This distance is comprised between 0.1*delta and 0.5*delta, where delta is equal to Ø/(2×tan(α/2)), and Ø represents the inlet diameter of the device, α being the angle between the first and the second directions of the split beams. α is equal to (180−A)·(n−1) in degrees, where A represents the apex angle or apex of the bi-prism and n the refractive index of the prism material, generally n˜1.5. As an alternative, the distance between the non-linear optical crystal 20 and the bi-prism may be determined experimentally. The diameter Ø is selected as a function of the angle of the bi-prism: Ø is higher than 2 mm for a bi-prism having a wide angle, of the order of 150 degrees of apex and Ø is higher than 4-5 mm for a bi-prism having a low angle, of the order of 175 degrees of apex.

At the exit of the non-linear optical crystal 20 is obtained an autocorrelation trace of the incident light pulse that is doubled in frequency, also called second-order autocorrelation trace, having an optical frequency 2ω. The second-order interferometric autocorrelation trace is propagated on the bisector of the first direction and the second direction of the split beams.

A spectral filter 21 is arranged between the non-linear optical crystal 20 and the camera 30. This spectral filter 21 allows filtering the two replicas of the fundamental beam and receiving only the doubled beam on the detector.

An optical system, for example with a lens 22, forms the image of the non-linear optical crystal 20 on a spatially-resolved image detector 30. The optical system of focal length f is preferably in optical conjugation 2f-2f with a magnification of 1 for reasons of compactness, nevertheless other magnifications higher than 1 may be used to improve the resolution. If a very high magnification is desired, it becomes generally necessary to fold the beam at least once to make the system more compact.

A second iris 23 allows spatially filtering the autocorrelation trace propagating along the axis of propagation of the incident light pulse. Preferably, the second iris 23 is placed near the focal point of the lens 22. In a first configuration, the second iris 23 is open, so as to let through, on the one hand, the autocorrelation beam propagating along the bisector of the first and second directions, and on the other hand, at least one of the deflected beams propagating along the first and/or the second direction, wherein these deflected beams can be at the optical frequency ω and 2ω. In a second configuration, the second iris 23 is partially closed so as to block the beams deflected by the bi-prism that propagate along the first and the second directions, while letting through the autocorrelation beam propagating along the bisector of the first and the second directions.

When the iris 23 lets through only the central beam corresponding to the autocorrelation trace, an intensimetric autocorrelation trace is detected. Hence, the image detector receives only the second-order autocorrelation trace propagating along the longitudinal optical axis 60. In this case, a second-order intensimetric autocorrelation trace is obtained.

In the case where the second iris 23 lets through the central beam and at least one of the two lateral beams (that are consisted of frequencies ω and 2ω or only 2ω if the fundamental frequency ω is filtered), an interferometric autocorrelation trace is obtained. The use of only two beams allows being less sensitive to the alignment.

By simply modifying the aperture of the iris 23, an interferometric-mode single-shot autocorrelation trace measurement and an intensimetric-mode single-shot autocorrelation trace measurement are hence performed sequentially. Nevertheless, in the embodiments of FIGS. 6 and 8, the intensimetric and interferometric measurements may be performed simultaneously.

In interferometric mode, the size of the fringe spacing on the detector 30 depends on the angle between the beams and on the wavelength and the magnification. The image detector 30 is spatially resolved in at least one direction transverse to the interferometric image. The optical combination of the optical system 22 and of the image detector 30 is configured to provide a spatial resolution adapted to resolve the fringes of the image of the autocorrelation interferometric beam on the image detector 30. For a magnification of 1, an angle between the beams of 2.5 degrees and a wavelength of 400 nm, the fringe spacing is equal to about 15 micrometres, i.e. approximately 3 pixels for a camera having a pixel size of 5 micrometres. The image detector 30 has a sensitivity over a wide spectral range.

In an exemplary embodiment, the image detector 30 is a camera spatially resolved in two directions (X, Y) transverse to the longitudinal optical axis 60. The camera is oriented so that the direction X is parallel to the edge of the Fresnel bi-prism 10 and the direction Y perpendicular to the edge of the Fresnel bi-prism 10.

The detector 30 hence provides a measurement spatially resolved along the axis X representative of the second-order autocorrelation interferometric trace or of the first-order or second-order interferometric autocorrelation trace along the spatial and/or spectral filtering applied.

FIG. 2 illustrates a variant of the first embodiment of the invention. The same elements are indicated in FIG. 2 by the same reference signs as in FIG. 1. In this variant, the Fresnel bi-prism 10 of FIG. 1 is replaced by a Fresnel bi-mirror 11. The edge of the Fresnel mirror 11 is arranged transversally to the longitudinal optical axis 60 of the incident laser beam. The Fresnel bi-mirror 11 hence deflects the longitudinal optical axis. Similarly to the Fresnel bi-prism 10, the Fresnel bi-mirror 11 splits the wavefront of the incident beam into two spatially-split wavefronts, each split wavefront being deflected symmetrically with respect to the edge of the Fresnel bi-mirror 11.

The other elements are configured to operate in the same way as the same elements described hereinabove in relation with FIG. 1.

The advantage of the Fresnel bi-mirror 11 is to be non-dispersive and achromatic. The use of the Fresnel bi-mirror 11 is particularly advantageous in the case of an ultrashort laser pulse 1 of duration lower than about 30 fs. Preferably, the angle of the Fresnel bi-mirror 11 is arranged symmetrically with respect to the longitudinal angle of propagation of the incident pulse.

In an embodiment, the Fresnel bi-mirror is single-piece and the angle of the Fresnel bi-mirror 11 is fixed by construction. The Fresnel bi-mirror 11 has an angle preferably comprised between 0.5 and 10 degrees. For example, the Fresnel bi-mirror 11 may be consisted of two plane mirrors bonded to each other along an edge and forming an angle between the two mirrors. As an alternative, the angle of the Fresnel bi-mirror 11 is adjustable, preferably symmetrically, which allows adjusting the resolution of the measurement system as a function of the duration of the pulse to be measured. Advantageously, in this case, an optomechanical system is configured so as to produce a symmetrical rotation of the two half-mirrors about the axis of the bi-mirror. In the case where the angle of the Fresnel bi-mirror 11 is adjustable, an automated calibration procedure allows adjusting the output results as a function of this angle.

A measuring system, as illustrated in FIGS. 1 and 2, based on a Fresnel bi-prism or bi-mirror, is easy to integrate under vacuum, which is a definite advantage for the ultrashort pulses (<15 fs) whose dispersion in the air is sufficient to degrade the temporal properties of the pulse.

FIG. 3 schematically shows a system for measuring the duration and phase of a laser pulse based on a single-shot autocorrelator combined with an imaging spectrometer according to a second embodiment of the invention.

This system includes a first iris 2, a second iris 3, a Fresnel bi-mirror 11 and a non-linear optical crystal 20. The operation of this system is similar to that in relation with FIG. 2, up to the non-linear optical crystal 20. The image detector 30 of FIG. 2 is herein replaced by a mini-imaging spectrometer (MIS). More precisely, the system of FIG. 3 comprises a mirror 25, a lens 26, a selection diaphragm 23. The imaging spectrometer 50 comprises an inlet slot 51, a lens 52, a transmission diffraction grating 53, another lens 54, an image detector 35 and a connector 45 connected to a signal processing computer.

For example, lenses 52, 54 of diameter 12 mm, focal length 20-50 mm, that are not very chromatic or achromatic, are used. The material of the lenses 52, 54 is for example calcium fluoride or magnesium fluoride or barium fluoride, whose refractive index varies slowly as a function of the wavelength. Advantageously, the image detector 35 is consisted of a camera. By way of example, a CCD or CMOS camera with 1.5 Mpixels, operating at a frequency of 10 to several hundreds of images/second, is used. The camera is adapted as a function of the spectral range of the pulse to be measured. The camera may be a UV, visible and/or infrared camera.

The mirror 25 serves to fold the optical path and to reduce the size of the system. The lens 26 forms the image of the non-linear optical crystal 20 on the inlet slot 51 of the image spectrometer 50. The inlet slot 51 is preferably rectangular in shape. The length of the inlet slot 51 is arranged perpendicular to the image of the autocorrelation trace on this slot and hence perpendicular to the edge of the bi-mirror. For example, the slot has a width of 10 to 50 micrometres. Hence, the inlet slot spatially selects a zone of the second-order autocorrelation trace. The slot 51 is located at the focal point of the lens 52 that hence forms a collimated beam directed towards the diffraction grating 53. The diffraction grating 53 spectrally scatters the autocorrelation trace on the image detector 35 spatially resolved in two dimensions. The second lens 54 forms the image of the slot 51 on the detector 35. The mini-imaging spectrometer 50 forms the image of the spectrally-scattered inlet slot. It is hence obtained a trace of the FROG type (for “Frequency-Resolved Optical Grating”) that represents a spectrogram having a spectral dimension and a temporal dimension.

When the iris 23 lets through only the central beam corresponding to the autocorrelation trace, it is detected on the image detector 35 a spectrally-resolved second-order intensimetric autocorrelation trace or second-order intensimetric FROG trace.

In the case where the diaphragm 23 lets through the central beam and at least one of the two lateral beams, it is obtained a spectrally-resolved interferometric autocorrelation trace or a second-order interferometric FROG trace.

By simply modifying the aperture of the iris 23, a spectrally-resolved interferometric-mode single-shot autocorrelation trace measurement and a spectrally-resolved intensimetric-mode single-shot autocorrelation trace measurement are hence performed sequentially.

An application of this measurement system is the measurement of the duration and phase of a pulse.

The signal processing system allows determining the spectral profile, the temporal profile and the phase of the ultrashort pulse 1 via an iterative algorithm of the PCGPA type (Principal Component Generalized Projections Algorithm, D. Kane, in IEEE J. Quant. Elec. 35, p.421 (1999)) or via another method of calculation of the phase based on the interferometric FROG trace (G. Stibenz and G. Steinmeyer, “Interferometric frequency-resolved optical gating”, Opt. Express 13 (7), 2617 (2005)).

The same elements are denoted in FIGS. 3, 4 and 5 by the same reference signs.

FIG. 4 schematically shows a first variant of the second embodiment of the invention. In this variant, the lens 26 has been replaced by a mirror-based optical system 27, 28 that forms an image of the non-linear crystal image 20 on the inlet slot 51 of the imaging spectrometer 50. The diffraction grating 56 is herein a transmission grating. Another lens 57 forms the image of the FROG trace on the detector 35. Moreover, in this imaging spectrometer 50, the lens 52 has been replaced by a spherical mirror 55, the inlet slot being placed at the focal point of this spherical mirror 55. The optical system consisted by the spherical mirror 27 and the extraction mirror 28 (pick-off mirror) allows directing the beam with an incidence angle close to zero degree to the spherical mirror(s) 55 and hence strongly reducing the geometric optical aberrations, such as the astigmatism. FIG. 4 hence shows a system for measuring the phase and the duration of a pulse comprising a single-shot interferometric autocorrelator combined to an imaging spectrometer, this measurement system being corrected for the geometric and essentially achromatic optical aberrations up to the diffraction grating 56.

FIG. 5 schematically shows a second variant of the second embodiment of the invention. In this variant, the spherical mirror 55 of FIG. 3 has been replaced by a mirror system 58, 59. The mirror 58 is a focusing mirror. The mirror 59 is an extraction mirror (pick-off mirror) that allows directing the beam with a low incidence in order to limit the geometric optical aberrations. The system of FIG. 5 has the advantage to be both achromatic and of small size thanks to the use of extraction mirrors (or pick-off mirrors) 27, 59. This configuration makes the system particularly compact.

In FIGS. 3, 4 and/or 5, the system has the following specificities:

the use of two iris very distant from each other, the first iris 2 being placed at the entry of the system and the second selection iris 23 being placed in front the detector, allows defining an accurate optical axis and facilitating the alignment of the complete system;

the use of a bi-mirror allows the automatic alignment and synchronization of the two half-beams relative to each other;

the imaging spectrometer with a transmission grating is compact;

the specific sizing of the minimum beam diameters as a function of the pulses allows reducing the focal lengths (f<50 mm) while avoiding the aberrations, hence both optimized achromaticity and compactness. All the beams are in the same plane and all the optical components are used at their optimum in the Gaussian conditions.

Moreover, in all the devices of FIGS. 3, 4 and 5, the last imaging optical element, in front of the detector, is always a lens. Nevertheless, the chromaticity of this lens is compensated by a detector tilt allowing intercepting different imaging depths as a function of the position.

FIG. 6 schematically shows a particular embodiment of the invention based on an interferometric and intensimetric autocorrelator measuring simultaneously the first and the second orders. The system of FIG. 6 includes a first iris 2, a Fresnel bi-prism 10, a non-linear crystal image 20, a lens 22, a spatial filter 24, a spectral filter 21 and an imaging detector 30 spatially resolved in two directions, of the CCD camera type, for example, of interferometric resolution. The lens 22 forms the image of the three beams propagating respectively along the first direction, the second direction, and the bisector of the first and second directions. A spatial filter 24 is arranged in the vicinity of the focusing plane of lens 22. This spatial filter includes a first open zone 241 and a second zone 242 including two shutters 243, 244. The first zone and the second zone are arranged so as to be simultaneously on the optical path of the three beams. Hence, the central beam corresponding to the intensimetric autocorrelation trace is not blocked whereas the two lateral beams are half-blocked so that they extend over only half the detector, so that only the upper part of the detector receives interferometric autocorrelations whereas the lower part of the detector receives a second-order intensimetric autocorrelation.

Particularly advantageously, this second filtering zone also introduces an optical density in order to attenuate the signal at ω so that it is comparable in intensity with the signal at 2ω of the first detection zone, so that the signals of the first zone and of the second zone can be detected simultaneously without damaging or saturating the detector. An example of configuration is illustrated in the insert 31 that represents a view in the plane of the filter 24. In this example, the first zone 241 is arranged so as to let through the three half-beams 310, 311, 312 towards a first detection area of the detector 30 and the second zone 242 is arranged so as to let through only the central half-beam 310, the shutters 243 and 244 blocking the lateral half-beams 311, 312 towards a first detection area of the detector 30. Hence, the combination of the first zone 241 of the spatial filter 24 and of the first area of the detector allows detecting a three-beam interferometric autocorrelation trace. More particularly, in this embodiment, the spectral filter 21 is placed in front of the detector 30. Advantageously, the spectral filter 21 includes two spectral filtering zones 211, 212. A first zone 211 filters the signal at the fundamental frequency (ω) and a second zone 212 filters the signal at the double frequency (2ω). Preferentially, the zone 211 includes a neutral optical density (OD of 3 to 6) to compensate for the difference of intensity between the beam at the double frequency and the beam at the fundamental frequency. Advantageously, the first spectral filtering zone 211 corresponds to 25% of the surface of the spectral filter 21 and the second spectral filtering zone 212 corresponds to 75% of the surface of the spectral filter 21. When the spectral filter used to block the fundamental frequency (ω) is a dichroic filter, the mean power of the incident beam may reach almost 10 W. On the other hand, it has also been measured pulses of 0.3 nJ at 60 MHz, i.e. 20 mW of mean power, corresponding to an intensity of about 10⁴ W/cm².

Preferably, the first zone 211 and a part of the second zone 212 are arranged between the spatial filter 24 and the first area of the detector, so as to allow spatially separating on the detector, on the one hand, a first-order interferometric autocorrelation trace in a first detection zone of the detector, and on the other hand, a second-order interferometric autocorrelation trace in a second detection zone of the detector. The other part of the second zone 212 of the spectral filter at the double frequency is placed between the spatial filter 24 and the second area of the detector, so as to form a second-order intensimetric autocorrelation trace in the second area of the detector. In total, in this first example, the combination of the spatial filter 24, the dual-zone spectral filter 21 and the image detector 30 allows measuring simultaneously and on a single-shot basis: the second-order intensimetric autocorrelation trace (SI), the second-order three-beam interferometric autocorrelation trace (S_{interf}(2ω)) and the first-order three-beam interferometric autocorrelation trace (S_{interf}(ω)).

A processing of these first-order and second-order intensimetric and interferometric autocorrelation measurements allows extracting a measurement of the duration and phase of the pulse 1 directly based on the autocorrelations with a suitable signal processing and on the fundamental spectrum obtained based on the first-order autocorrelation. This hence constitutes an advantageous alternative to the prior FROG methods that require more complexity and a heavy iterative algorithm to calculate the phase and the temporal profile.

FIG. 7 schematically shows another particular embodiment of the invention based on an interferometric autocorrelator. The same reference signs denote the same elements as in FIG. 6. Unlike the system shown in FIG. 6, the system of FIG. 7 does not include a spatial filter but only a dual-zone spectral filter 21. The filter 21 includes a first spectral filtering zone 211 filtering the signal at the fundamental frequency (ω) and a second spectral filtering zone 212 filtering the signal at the double frequency (2ω). On this account, the first spectral filtering zone 211 corresponds to 50% of the surface of the spectral filter 21 and the second spectral filtering zone 212 corresponds to 50% of the surface of the spectral filter 21.

In this variant, it is measured simultaneously and on a single-shot basis: the first-order two-beam interferometric autocorrelation trace (S_{interf}(ω)) (because the central beam is only at the double frequency) and the second-order three-beam interferometric autocorrelation trace (S_{interf}(2ω)) on a single and same detector spatially resolved in two dimensions. A processing of these two first-order and second-order interferometric autocorrelation measurements allows extracting a measurement of the duration and phase of the wavefront 1 of the single-shot laser pulse.

The signal processing system calculates the spectrum of the ultrashort pulse 1, by application of an operation of Fourier transform to the measurement of the first-order autocorrelation trace.

A computer connected to the camera 30 processes the different first-order and second-order interferometric and/or intensimetric autocorrelation measurements. The input data are the spectrum (or the first-order autocorrelation trace) and the second-order interferometric autocorrelation trace (FIG. 7) on the on hand, or the second-order intensimetric autocorrelation trace, the spectrum (or the first-order autocorrelation trace), and the second-order interferometric autocorrelation trace (FIG. 6), on the other hand. The output of the processing software comprises displaying these inputs and calculating the spectral phase and the temporal intensity and phase profile.

In another embodiment, the spectrum of the pulse may be imported as data recorded from a separated device of the spectrometer type, to allow the reconstruction of the temporal profile.

As an alternative, as illustrated in FIG. 8, a mini spectrometer may be integrated to the measurement system in order to collect the spectrum in real time. The mini spectrometer is integrated to the device after the bi-prism to collect the spectrum of the ultrashort pulse by diffusion on the optical components or by means of a pick-off fibre 71 positioned to intercept a beam part that does not intervene later in the autocorrelation.

According to another alternative, the first-order autocorrelation trace is used to calculate the fundamental spectrum by Fourier transform. In this latter embodiment, a spectral filter with two spectral zones 21 and 21bis is used in order to filter the fundamental over a part of the detector and the doubled beam over another part of the detector (see FIGS. 6-7).

The measurement system takes advantage of the spatial resolution of the image detector to allow measuring simultaneously, for example the first-order and second-order autocorrelation signals. Consequently, the information relating to the spectrum and to the interferometric autocorrelation may be extracted from a same image acquired based on an ultrashort laser pulse. Hence, the single-shot measurement device allows reconstructing the temporal profile of an ultrashort laser pulse.

The manufacturing and use of this duration and phase measurement system are relatively simple, compared with the prior-art systems that are generally complex and difficult to use.

The system is easily configurable to provide either the duration and phase measurement, or only a duration measurement.

In another exemplary embodiment, the image detector 30 is for example a photodiode strip spatially resolved in a direction×transverse to the longitudinal optical axis 60. The photodiode strip is oriented so as to extend in a direction transverse to the edge of the Fresnel bi-prism 10. In this embodiment, the detector being not spatially resolved in the direction parallel to the edge of the Fresnel bi-prism 10, it is not possible to measure simultaneously on the image detector a first-order and second-order autocorrelation trace.

The initial calibration of the image detector essentially depends on the lens magnification, the detector resolution and the angle between the two beams determined by the angle of the bi-prism. The measurement system requires no calibration from the user, the adjustment performed in factory being valuable for the whole lifetime of the device. The fringe spacing of the second-order autocorrelation interferometric beam corresponds to a wavelength, at the optic frequency 2ω, i.e. 2 fs at 400 nm. Another benefit of the simplicity of the system is that it requires no adjustment, which allows having reproducible measurements whatever the user. Moreover, this measurement system is compact and easy to use. The implementation of this measurement system on a laser line may be performed within a few minutes, whereas the alignment of a conventional autocorrelator or a phase measurement device may take several hours, or more.

The compactness of the duration and phase measurement system allows its easy integration into a laser for OEM applications.

FIG. 8 shows a measurement system according to another embodiment comprising a second-order autocorrelator combined with a spectrometer. The same reference signs denote the same elements as in FIG. 6 or 7. In this embodiment, a spectrometer 70 is used, for example coupled via an optical fibre 71, to record the intensity I(λ) of the pulse 1 as a function of the wavelength, in other words the spectrum of the light pulse 1.

A spectral filter 21 is placed between the non-linear crystal image 20 and the focusing lens 22. The spectral filter 21 let through only the signals at the double optical frequency (2ω). Optionally, a spatial filter 29 may be placed in the focal plane of the lens 22. This spatial filter 29 allows in particular eliminating the spurious diffraction on the edge of the bi-prism.

A first example of configuration of the spatial filter 24, illustrated in the insert 31, is similar to the embodiment described in relation with FIG. 6. In total, in this first example of FIG. 8, the combination of the spectral filter 21, the spatial filter 24 and the image detector 30 allows measuring simultaneously and on a single-shot basis: a second-order intensimetric autocorrelation trace and a second-order three-beam interferometric autocorrelation trace.

A second example of configuration is illustrated in the insert 32 that shows a view in the plane of the filter 24. In this second example, the first zone 241 is arranged so as to let through two half-beams 310, 311 towards a first detection area of the detector 30, the shutter 244 blocking the half-beam 312. Hence, the combination of the first zone 241 of the spatial filter 24 and of the first area of the detector allows detecting a two-beam interferometric autocorrelation trace. As in the first example, the second zone 242 is arranged so as to let through only the central half-beam 310 towards a first detection area of the detector 30, the shutters 243 and 244 blocking the lateral half-beams 311, 312. In total, in this second example, the combination of the spectral filter 21, the spatial filter 24 and the image detector 30 allows measuring simultaneously and on a single-shot basis: the second-order intensimetric autocorrelation trace (SI), the second-order two-beam interferometric autocorrelation trace (S_{interf}(2ω)).

A computer collects and performs the processing of the measured spectrum (I(X)) and second-order intensimetric and interferometric autocorrelation signals ((S.I (2ω), Sinterf (2ω)). The processing of these signals allows extracting a measurement of the duration or of the intensity profile and of the phase of the wavefront 1 of the input laser pulse.

In the embodiments described with reference to FIGS. 3, 4 and 5 (FROG method), the fundamental spectrum may be detected either sequentially using the second order of diffraction of the grating, or simultaneously using a detector of greater spatial size and a suitable optical density or a second detector. The knowledge of the fundamental spectrum allows giving a criterion of convergence for the FROG algorithm and hence improving the quality of the measurements.

In the embodiments corresponding to FIGS. 1 to 5, a cylindrical lens may be placed upstream the system, in order to allow measurement with very low energy. In this case, the cylindrical lens must be perfectly aligned and the focal point must be positioned on the non-linear crystal in order to produce a reliable measurement.

In all the embodiments, a dispersive or non-dispersive afocal optical system may be placed upstream the device in order to magnify the beam when the size is not sufficient for the pulse duration to be measured.

1-15. (canceled)

16. A system for measuring the duration, the temporal profile and the spectrum of an ultrashort laser pulse, wherein the measurement system includes a single-shot optical autocorrelator comprising:
a wavefront-splitting optical component arranged so as to receive a collimated wavefront of fundamental optical frequency ω coming from an ultrashort laser pulse source and to spatially split the collimated wavefront of an ultrashort light pulse into a first split wavefront propagating along a first direction and a second split wavefront propagating along a second direction forming a non-null angle with the first direction,
a non-linear optical crystal arranged at a determined distance from the wavefront-splitting optical component so that the first split wavefront and the second split wavefront are superimposed to each other in the non-linear optical crystal,
an optical system forming an image of the non-linear optical crystal on a detection system spatially resolved in at least one direction,
a filtering device arranged between the non-linear optical crystal and the detection system, the filtering device and the detection system being configured to detect, on the one hand, a second-order single-shot interferometric autocorrelation trace at the double optical frequency 2ω and, on the other hand, at least another single-shot autocorrelation trace of the first-order interferometric type at the fundamental optical frequency ω or of the second-order intensimetric type at the double optical frequency 2ω, and in that
the measurement system includes a signal processing system configured to analyse, on the one hand, the second-order single-shot interferometric autocorrelation trace at the double optical frequency 2ω and, on the other hand, the other single-shot autocorrelation trace, and to deduce therefrom a measurement of the duration, the temporal profile and the spectrum of an ultrashort laser pulse.

17. The system for measuring the duration, the temporal profile and the spectrum of an ultrashort laser pulse according to claim 16, wherein the wavefront-splitting optical component includes a Fresnel bi-prism or a Fresnel bi-mirror having a fixed or symmetrically adjustable apex angle.

18. The system for measuring the duration, the temporal profile and the spectrum of an ultrashort laser pulse according to claim 17, wherein the distance D between the wavefront-splitting optical component and the non-linear optical crystal is comprised between: 0.1*delta and 0.5*delta, where delta is equal to
$$\frac{∅}{2 \times tan ( \frac{α}{2} )} ,$$
and where Ø is the inlet diameter of the device and where α is equal to (180−A)·(n−1), where A represents the apex angle or apex of the Fresnel bi-prism and n the refractive index of the prism material or, respectively, α is equal to 2*(180−A) for a Fresnel bi-mirror, where A represents the apex of a bi-prism complementary of the bi-mirror.

19. The system for measuring the duration, the temporal profile and the spectrum of an ultrashort laser pulse according to claim 18, including a plurality of Fresnel bi-prisms each having a determined apex angle and further comprising a switching system adapted to select a Fresnel bi-prism among the plurality of Fresnel bi-prisms and to place the selected bi-prism at a distance D from the non-linear optical crystal.

20. The system for measuring the duration, the temporal profile and the spectrum of an ultrashort laser pulse according to claim 18, including a plurality of Fresnel bi-prisms each having a determined apex angle and further comprising a switching system adapted to select a Fresnel bi-prism among the plurality of Fresnel bi-prisms and to place the selected bi-prism at a distance D from the non-linear optical crystal.

21. The system for measuring the duration, the temporal profile and the spectrum of an ultrashort laser pulse according to claim 16, wherein the non-linear optical crystal has a thickness higher than or equal to 5 micrometres and a suitable phase matching to allow a second harmonic generation in a spectral range comprised between 0.4 and 12 micrometres.

22. The system for measuring the duration, the temporal profile and the spectrum of an ultrashort laser pulse according to claim 16, wherein the filtering device includes a spatial filter able to be switched in opening between a first and a second opening, the first opening being configured to let through to the detection system, on the one hand, the direction of propagation of the bisector of the first and second directions and, on the other hand, the first direction and/or the second direction, so as to form the second-order single-shot interferometric autocorrelation trace, and, respectively, the second opening being configured to selectively let through to the detection system the axis of propagation along the bisector of the first and second directions, while blocking the first and second directions to form the other single-shot autocorrelation trace of the second-order intensimetric type.

23. The system for measuring the duration, the temporal profile and the spectrum of an ultrashort laser pulse according to claim 16, wherein the filtering device includes a spectral filter configured to selectively filter the double optical frequency 2ω and to block the fundamental optical frequency ω.

24. The system for measuring the duration, the temporal profile and the spectrum of an ultrashort laser pulse according to claim 16, wherein the detection system includes a camera comprising a first and a second spatially-resolved detection zones and wherein the filtering device includes a spectral filter having a first and a second spectral filtering zones, the first spectral filtering zone being configured to selectively let through the double optical frequency 2ω to the first detection zone while blocking the fundamental optical frequency ω, and the second spectral filtering zone being configured to selectively let through the fundamental optical frequency ω to the second detection zone while blocking the double optical frequency 2ω.

25. The system for measuring the duration, the temporal profile and the spectrum of an ultrashort laser pulse according to claim 16, wherein the detection system includes a camera comprising a first and a second spatially-resolved detection areas and wherein the filtering device includes a spatial filter having at least one first spatial filtering zone and a second spatial filtering zone, the first spatial filtering zone being configured to let through, on the one hand, the direction of propagation of the bisector of the first and second directions and, on the other hand, the first and/or the second direction, to the first detection area, so as to form the second-order single-shot interferometric autocorrelation trace, and respectively, the second spatial filtering zone being configured to selectively let through the direction of propagation along the bisector of the first and the second directions while blocking the first and second directions towards the second detection area, to form the other single-shot autocorrelation trace of the second-order intensimetric type.

26. The system for measuring the duration, the temporal profile and the spectrum of an ultrashort laser pulse according to claim 16, further comprising a spectrometer configured to record a spectrum of the light pulse, and wherein the signal processing system is configured to deduce therefrom a measurement of the light pulse phase.

27. The system for measuring the duration, the temporal profile and the spectrum of an ultrashort laser pulse according to claim 16, wherein the detection system includes an imaging spectrometer having an inlet slot, a spectrally-dispersive optical system and a detector spatially resolved in two directions, the filtering device and the imaging spectrometer being configured to detect, on the one hand, a spectrally-resolved second-order single-shot intensimetric autocorrelation trace, and on the other hand, a spectrally-resolved single-shot interferometric autocorrelation trace.

28. The system for measuring the duration, the temporal profile and the spectrum of an ultrashort laser pulse according to claim 26, wherein the spectrally-dispersive optical system comprises a transmission or reflection diffraction grating.

29. The system for measuring the duration, the temporal profile and the spectrum of an ultrashort laser pulse according to claim 27, wherein the optical system forming the image of the non-linear optical crystal on the inlet slot of the imaging spectrometer includes an achromatic optical system comprising a first spherical mirror illuminated with an incidence angle lower than 4 degrees, and a second mirror configured to separate a reflected optical beam from an incident optical beam on the first spherical mirror.

30. The system for measuring the duration, the temporal profile and the spectrum of an ultrashort laser pulse according to claim 28, wherein the optical system forming the image of the non-linear optical crystal on the inlet slot of the imaging spectrometer includes an achromatic optical system comprising a first spherical mirror illuminated with an incidence angle lower than 4 degrees, and a second mirror configured to separate a reflected optical beam from an incident optical beam on the first spherical mirror.

31. The system for measuring the duration, the temporal profile and the spectrum of an ultrashort laser pulse according to claim 27, wherein the imaging spectrometer includes another mirror-based achromatic optical system configured to form an image of the inlet slot on the detector, the other mirror-based achromatic optical system comprising a spherical mirror illuminated with an incidence angle lower than 3 degrees, and another mirror configured to separate a reflected optical beam from an incident optical beam on said spherical mirror.

32. The system for measuring the duration, the temporal profile and the spectrum of an ultrashort laser pulse according to claim 28, wherein the imaging spectrometer includes another mirror-based achromatic optical system configured to form an image of the inlet slot on the detector, the other mirror-based achromatic optical system comprising a spherical mirror illuminated with an incidence angle lower than 3 degrees, and another mirror configured to separate a reflected optical beam from an incident optical beam on said spherical mirror.

33. The system for measuring the duration, the temporal profile and the spectrum of an ultrashort laser pulse according to claim 29, wherein the imaging spectrometer includes another mirror-based achromatic optical system configured to form an image of the inlet slot on the detector, the other mirror-based achromatic optical system comprising a spherical mirror illuminated with an incidence angle lower than 3 degrees, and another mirror configured to separate a reflected optical beam from an incident optical beam on said spherical mirror.

34. The system for measuring the duration, the temporal profile and the spectrum of an ultrashort laser pulse according to claim 16, further including an optical alignment diaphragm adjacent to the wavefront-splitting optical component, the alignment diaphragm being positioned vertically above the first foot of the device, hence forming a pivot point for the alignment of the device to the optical axis.
